(19) United States
(12) Patent Application Publication
(10) Pub. No.: US 2013/0073681 A1
(43) Pub. Date: Mar. 21, 2013

(54) CREATING INTERACTIVE ZONES

(71) Applicants: Xiaofan Jiang, Beijing (CN); Jie Liu, Medina, WA (US); Feng Zhao, Bellevue, WA (US); Jeff Hsu, Los Angeles, CA (US); Caiquan Liu, Chengdu (CN); Chieh-Jan Mike Liang, Beijing (CN)

(72) Inventors: Xiaofan Jiang, Beijing (CN); Jie Liu, Medina, WA (US); Feng Zhao, Bellevue, WA (US); Jeff Hsu, Los Angeles, CA (US); Caiquan Liu, Chengdu (CN); Chieh-Jan Mike Liang, Beijing (CN)

(73) Assignee: Microsoft Corporation, Redmond, WA (US)

(21) Appl. No.: 13/235,077

(22) Filed: Sep. 16, 2011

(51) Int. Cl. G06F 15/16

(52) U.S. Cl. 709/218; 709/217

(57) ABSTRACT

Some implementations disclosed herein provide techniques and arrangements to enable interactive zones. For example, some implementations detect that a user has entered a zone associated with a physical object, where the zone is created via magnetic induction. In response to detecting that the user has entered the zone, some implementations send a virtual object representation of the physical object to a user device (e.g., a wireless phone) associated with the user. The user may interact with the virtual object, including selecting a command associated with the virtual object. Selecting the command may cause the physical object to perform one or more actions. In some implementations, a result of the physical object performing the one or more actions is sent to the user device.

### BACKGROUND

An architecture to enable users and their environment to discover, identify, and interact with each other may be difficult to successfully implement because reliable indoor proximity sensing is difficult to implement. For example, radio frequency (RF) signals may have non-isotropic radiation patterns in indoor environments. Long-range RF identifier (ID) based solutions may be expensive and require deployment of many large readers. Computer vision techniques may be too coarse to detect fine motions, may intrude upon user privacy, and may be easily confused by furniture, lighting conditions, and other people in the space. Infrared systems typically have difficulty localizing objects in environments with fluorescent lighting or direct sunlight and offer poor granularity for small spaces. Inertia-sensing approaches, such as double-integration of accelerometer data, may be inaccurate due to large direct current (DC) offset errors and may use set beacons that require frequent re-calibration. Global Positioning Satellite (GPS) technology requires a direct line of sight to satellites and so is not readily deployable indoors and also lacks the fine granularity that is useful for smaller objects. Ultrasound technologies may be computationally intensive, require the deployment of expensive infrastructure (e.g., ceiling sensor grids), and may suffer from multipath effect. WiFi® fingerprint-based positioning typically requires a time-consuming training phase and may require costly recalibration when the environment changes. In addition, WiFi® may suffer from multipath effect and Rayleigh fading that result in inaccurate location estimations. Pressure-sensitive floor sensors do not scale well for large systems and are difficult to configure for use with lightweight objects, such as laptop computers.

In addition, some proximity sensing technologies may not be suitable for interacting with humans. For example, some sensing technologies may require explicit user actions for discovery, such as taking a picture, scanning an RF identifier (RFID) tag, or physically touching an object, while other technologies may be too coarse to enable pinpointing objects or people to within a few meters.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide techniques and arrangements to enable interactive zones. For example, some implementations detect that a user has entered a zone associated with a physical object. In some implementations, the zone is created via magnetic induction. In response to detecting that the user has entered the zone, some implementations send a virtual object representation of the physical object to a user device (e.g., a wireless phone) associated with the user. The user may interact with the virtual object, including selecting a command associated with the virtual object. Selecting the command may cause the physical object to perform one or more actions. In some implementations, a result of the physical object performing the one or more actions is sent to the user device.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example framework for creating interactive zones according to some implementations.

FIG. 2 illustrates an example of a physical environment hierarchy according to some implementations.

FIG. 3 illustrates an example framework for creating an interactive virtual world according to some implementations.

FIG. 4 illustrates an example hardware architecture for creating interactive zones according to some implementations.

FIG. 5 illustrates an example framework for creating interactive zones according to some implementations.

FIG. 6 is a flow diagram of an example process that includes receiving a notification that a user has entered a zone according to some implementations.

FIG. 7 is a flow diagram of an example process that includes receiving an object discovery notification identifying a physical object according to some implementations.

FIG. 8 is a flow diagram of an example process that includes detecting that a user has entered a zone according to some implementations.

FIG. 9 is a block diagram of an example computing device according to some implementations.

### DETAILED DESCRIPTION

### Creating Interactive Zones Using Magnetic Induction

The technologies described herein generally relate to creating interactive zones that enable bi-directional information flow between humans, their physical environment, and objects (e.g., devices or rooms) within the physical environment. The technologies described herein provide reliable proximity sensing and interactive virtual object representations of physical spaces and objects, such as by using magnetic induction technology.

A device associated with a physical object, referred to herein as a zone device, may create a zone around the physical object via a magnetic field. A user may carry a user device, referred to herein as a user device, that is capable of discovering and interacting with zone devices. The user device may be a standalone device or its functionality may be incorporated into a computing device, such as a laptop computing device, tablet computing device, or wireless phone. For example, in some implementations, the user device may be a standalone device used to detect the presence of the user and a computing device associated with the user may be used to enable interaction with the physical object. Zone devices and user devices may communicate with each other via magnetic inductions, via a wireless local area network, or a combination of both.

The wireless local area network may include one or more servers that enable the user to interact with virtual objects that represent physical objects. As used herein, the term physical object may refer to a particular device or to a particular environment or area, such as a room or a workspace. The one or more servers may provide a virtual representation of a physical object that the user can interact with using the user device. For example, the user may, via interaction with a virtual object representation of a physical object, select a command associated with the virtual object that causes the physical object to perform one or more actions. As another example, the user may query a state of the physical object. As yet another example, the user may subscribe to one or more events to enable the user to receive one or more notification messages when the one or more events occur at the physical object.

### Interactive Zone

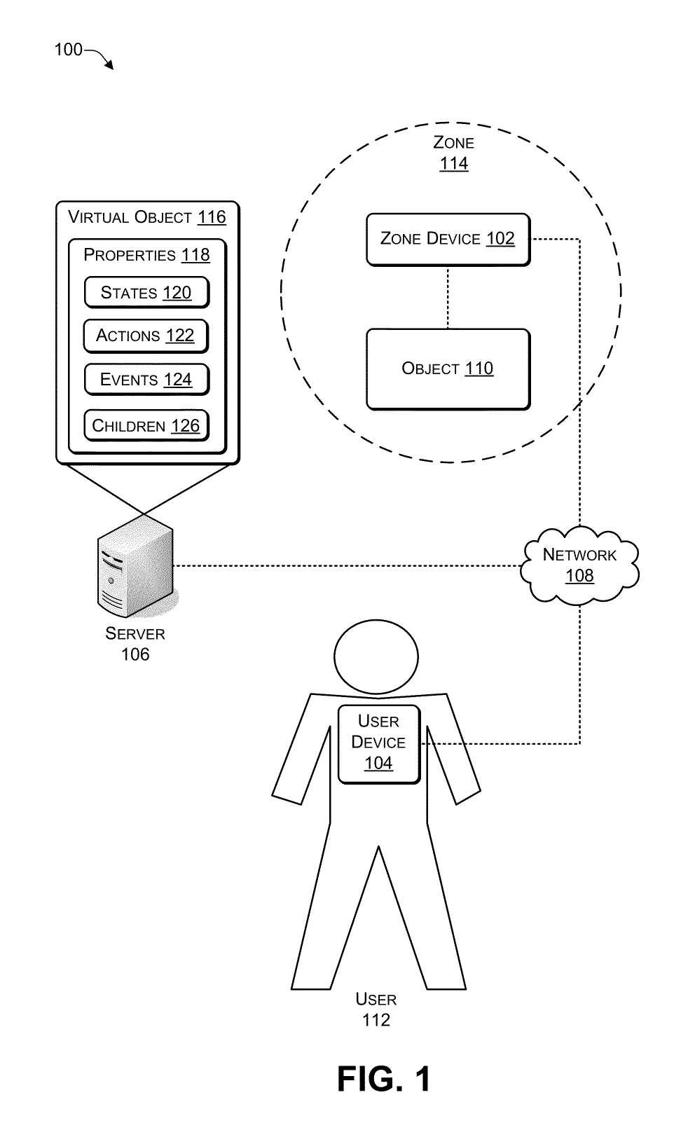

FIG. 1 illustrates an example of a framework 100 for creating interactive zones according to some implementations. The framework 100 may be executed by a computing device or other particular machine specifically configured with processor-executable instructions, as discussed additionally below.

The framework 100 includes a zone device 102, a user device 104, and a server 106 that are communicatively coupled to a network 108. The network 108 may include one or more networks, including a low power wireless local area network, a wireless wide area network (e.g., a code division multiple access (CDMA) or a global system for mobile (GSM) network), a wired network (e.g., Ethernet), other network, or any combination thereof.

The zone device 102 may be associated with an object 110. For example, the zone device 102 may be co-located with the object 110 or placed in close proximity to the object 110. In some implementations, the functionality of the zone device 102 may be incorporated into the object 110. For example, the functionality of the zone device 102 may be incorporated into appliances, such as refrigerators, washers, dryers, stoves, and ovens, to create interactive appliances.

The user device 104 may be associated with a user 112. For example, the user 112 may carry the user device 104 or attach the user device 104 to an article of clothing of the user 112. The user device 104 may be a standalone device, such as a tag, badge, token, wearable item, portable electronic device, or the like. For example, the user device 104 may include a magnetic transceiver to interact with the zone device and a wireless transceiver to communicate wirelessly with a computing device (e.g., wireless phone) associated with the user. Alternatively, the functionality of the user device 104 may be integrated into a computing device, such as a wireless phone or tablet computing device. The zone device 102 may generate a zone 114 associated with the object 110 using magnetic induction technology.

The server 106 may host virtual objects, such as a virtual object 116, that are virtual representations of objects, such as the object 110. When computationally-capable, zone device 102 (or object 110) may host virtual objects directly as well. The virtual object 116 includes properties 118 that enable the user 112 to interact with the object 110 via interaction with the virtual object 116. The properties 118 include states 120, actions 122, events 124, and children 126. When the object 110 includes other objects (e.g., rooms in a house or objects in a room), the relationship between the object 110 and the other objects may be expressed hierarchically. For example, the object 110 may be the parent node while the other objects are child nodes. The children 126 may provide information associated with the child nodes of the object 110.

The zone 114 may be used to detect when the user 112 with the user device 104 is sufficiently close to the object 110 to enable interaction. In response to the user device 104 detecting that the user 112 has entered the zone 114, the user device 104 may instruct the server 106 to provide the virtual object 116 to a user device of the user 112. In some implementations, the zone device 102 and user device 104 may perform a handshake as part of a discovery process prior to the virtual object 116 being provided to the user 112. The discovery process may be initiated by either the zone device 102 or by the user device 104. The discovery process may be performed via magnetic induction, via the network 108, or a combination of both. The discovery process may include informing the user 112 that the object 110 has been discovered and determining whether the user 112 desires to interact with the virtual object 116 representation of the object 110.

For example, in some implementations, the zone device 102 may detect that the user device 104 has entered the zone 114 generated by the zone device 102. In response, the zone device 102 may send a query to the user device 104 to determine whether the user 112 desires to interact with the object 110. If the zone device 102 determines that the user 112 desires to interact with the object 110, the zone device 102 may instruct the server 106 to send the virtual object 116 to a device (e.g., the user device 104 or a computing device) associated with the user 112.

In some implementations, the user device 104 may detect that the user device 104 has entered the zone 114 generated by the zone device 102. In response, the user device 104 may determine whether the user 112 desires to interact with the object 110. If the user device 104 determines that the user 112 desires to interact with the object 110, the user device 104 may instruct the server 106 to send the virtual object 116 to the user device 104 associated with the user 112.

The virtual object 116 may be sent to the user device 104 that is associated with the user 112. The user device 104 may display the properties 118 of the virtual object 116 to enable the user 112 to interact with the object 110 via the virtual object 116. For example, by interacting with the virtual object 116, the user 112 may determine which of the states 120 is currently associated with the object 110. As another example, by interacting with the virtual object 116, the user 112 may select one of the actions 122, causing the object 110 to perform the selected action. As yet another example, by interacting with the virtual object 116, the user 112 may subscribe to one of the events 124 and receive a notification when the event occurs.

To illustrate, when the object 110 is a computing device (e.g., desktop computer), the user 112 may determine, via the virtual object 116, that the object 110 currently has an “off” state. In some implementations, the virtual object 116 may periodically synchronize with the object 110 via the zone device 102 to enable the user 112 to determine the state of the object 110 by displaying a state of the virtual object 116. In other implementations, the virtual object 116 may, in response to a request for the state of the object 110 (e.g., on demand rather than periodically), send the request to the object 110 via the zone device 102 to determine the state of the object 110. After receiving the state of the object 110 from the zone device 102, the virtual object 116 may display the state of the virtual object 116.

After determining that the object 110 has an “off” state, the user 112 may select a “power on” action that causes the object 110 to initiate a power-on procedure. When the object 110 is a computer, the user 112 may subscribe to a “login” event that causes the user 112 to be sent a notification when specified user(s) login at the object 110. For example, in a home, a parent may receive a notification when a child performs a login at the computer. In an office, a supervisor may receive a notification when an employee performs a login at a particular computer.

Physical objects, such as the object 110, may be programmed to intelligently make decisions that lead to actions without any intervention with the user 112. For example, the object 110 may be programmed using a programming model for physical objects. In addition, the object 110 may be programmed to interact intelligently with other objects (not shown). For example, the object 110 and the zone device 102 may be programmed to collect data associated with each user that uses the object and provide the collected data to an administrator (not shown). To illustrate, when the object 110 is a refrigerator, the object 110 may detect the presence of the user 112 when the user 112 enters the zone 114, and automatically report this event to the administrator, without presenting the virtual object 116 or the properties 118 to the user 112. As another example, in a call center environment, each operator station may automatically detect the presence of an operator and automatically send the information to the server 106. The server 106 may automatically create a report and automatically send the report to a supervisor. The report may include information identifying which operator stations are occupied by an operator, when the operator logged in to the operator station, how long the operator has been logged in, an average number of calls serviced by the operator since the operator logged in, etc.

As another example, the object 110 may be a coffee maker. The user 112 may determine that the object 110 is in a “keep warm” state and that there is less than one cup of coffee in a carafe of the coffee maker. The user 112 may empty the carafe, add coffee, and, via the virtual object 116, select an action instructing the object 110 to initiate brewing a pot of coffee. The user 112 may subscribe to a “brewing completed” event and wait for a notification that the object 110 has completed brewing a pot of coffee. Alternately, after determining that there is less than one cup of coffee in the carafe of the coffee maker, the user 112 may subscribe to a “brewing initiated” event and wait for a notification that another user has initiated brewing a pot of coffee.

After detecting that the user 112 has entered the zone 114, the user device 104 or the zone device 102 may also detect when the user 112 has left the zone 114. In response, the user device 104 or the zone device 102 may perform one or more actions, including sending a notification to the server 106 that the user 112 has left the zone 114. For example, when the user 112 leaves the zone 114, the server 106 may determine whether the user 112 no longer desires to interact with the virtual object 116 to enable the virtual object 116 to be presented to another user for interaction. To illustrate, when the object 110 is a desktop computer, when the user 112 is detected in the zone 114, the user 112 may indicate that the user desires to interact with the object 110 via the virtual object 116. When the zone device 102 or the user device 104 detects that the user 112 has exited the zone 114, the server 106 may determine whether the virtual object 116 may be provided to another user. For example, the server 106 may ask whether the user 112 desires to end interaction with the virtual object 116.

Thus, the zone device 102 may generate the zone 114 around the object 110 to detect when a user 112 having the user device 104 has entered or exited the zone 114. When the user 112 is detected in the zone 114, the user 112 may be sent a virtual object 116 representation of the object 110. The user 112 may interact with the object 110 via the virtual object 116. For example, the virtual object 116 may enable the user 112 to determine one of the states 120 associated with the object 110, cause the object 110 to perform one or more of the actions 122, or receive notifications when one or more of the events 124 occur. Thus, the virtual object 116 provides enhanced interaction capabilities to the object 110 by enabling the object 110 to perform actions reactively and autonomously, such as in response to the user 112 entering or exiting the zone 114.

### Physical Environment Hierarchy

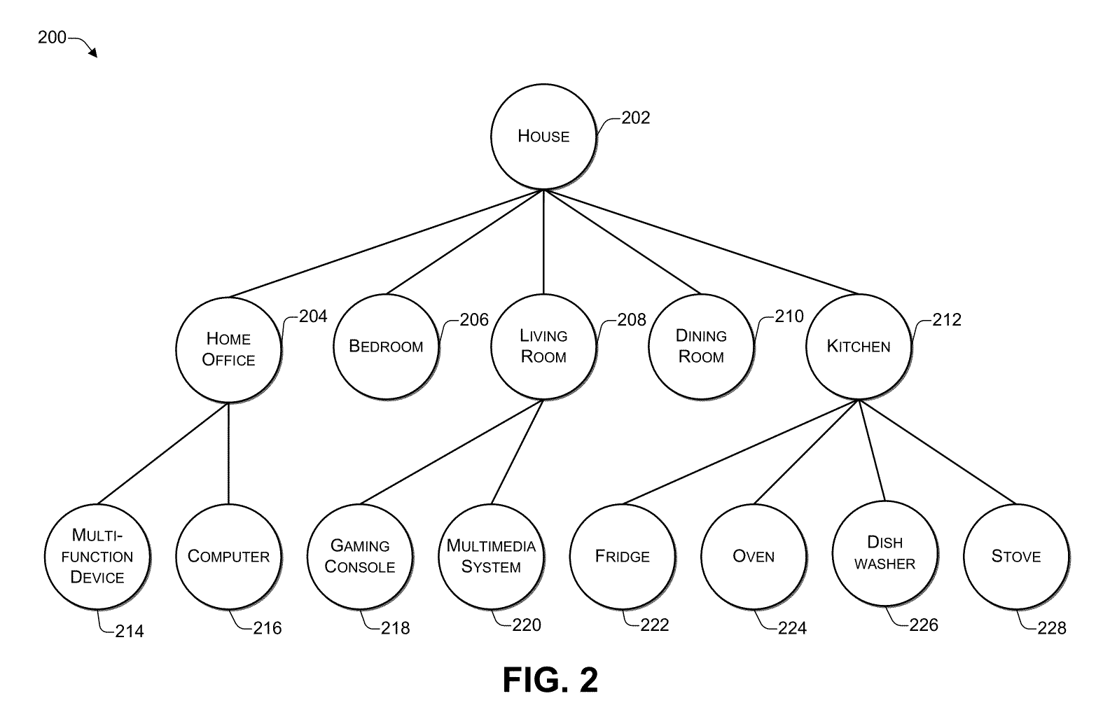

FIG. 2 illustrates an example of a physical environment hierarchy 200 according to some implementations. FIG. 2 illustrates how a physical environment, including rooms and objects in the physical environment, may be represented as a hierarchical structure. The physical environment hierarchy 200 may be used to create a hierarchical representation of a physical environment to enable a user to interact with the physical environment.

In the physical object hierarchy 200, a house 202 has multiple child nodes that represent the rooms in the house 202. The child nodes include a home office 204, a bedroom 206, a living room 208, a dining room 210, and a kitchen 212. One or more of the rooms 204, 206, 208, 210, and 212 may include additional child nodes. These additional child nodes may represent additional rooms or may represent objects (e.g., devices) that a user may interact with.

For example, the home office 204 may include a multi-function (e.g., print, fax, and scan) device 214 and a computer 216. The user 112 may interact with a virtual representation of the home office 204 that includes virtual representations of the multi-function device 214 and the computer 216. For example, the user 112 may place printed sheets in the multi-function device 214, and via interaction with a virtual representations of the home office 204, cause the multi-function device 214 to scan the sheets and cause the computer 216 to email the scanned sheets to a particular email address.

The living room 208 may include a gaming console 218 and a multimedia system 220. The multimedia system 220 may include various components, such as a television, a receiver, speakers, a compact disc (CD) player, a digital versatile disc (DVD) player, and a set-top box device. In some implementations, the multimedia system 220 may have a single virtual object representation that includes more than one physical object. For example, the user 112 may, via the virtual object representation, interact with the multimedia system 220 by selecting a “play DVD” action. In response, the multimedia system 220 may power on the DVD player, power on the receiver, power on the television, and select an input associated with the DVD player on the receiver.

The kitchen 212 may include a fridge 222, an oven 224, a dishwasher 226, and a stove 228. In some implementations, the user 112 may interact with one or more of the devices 222, 224, 226, and 228 via a single virtual object that represents the kitchen 212. The virtual object representation of the kitchen may be hierarchically navigated to enable interaction with the individual devices in the kitchen 212. For example, the user 112 may instruct the oven 224 to pre-heat to a particular temperature and subscribe to a temperature event that sends a notification to the user 112 when the oven 224 has been pre-heated to the particular temperature.

In some implementations, one or more of the rooms 204, 206, 208, 210, and 212 may have a virtual representation for the entire room rather than virtual representations for each of the individual objects in the room. For example, the room 208 may have a virtual representation that controls both the gaming console 218 and the various components of the multimedia system 220. In this example, the user may select from actions that include “play a game”, “listen to CDs”, “watch a DVD”, or “watch TV.”

Thus, a physical environment may be represented hierarchically, with child nodes representing rooms or devices in the rooms. The virtual object representation of such a physical environment may be hierarchically navigated by the user 112. In some implementations, a virtual representation may be provided for a room that includes one or more devices for ease of interaction. A zone device 102 may be located near each of the devices in the rooms 204, 206, 208, 210, and 212 to detect when the user 112 is close enough to interact with each of the devices.

### Enabling Enhanced Interaction Via a Virtual World

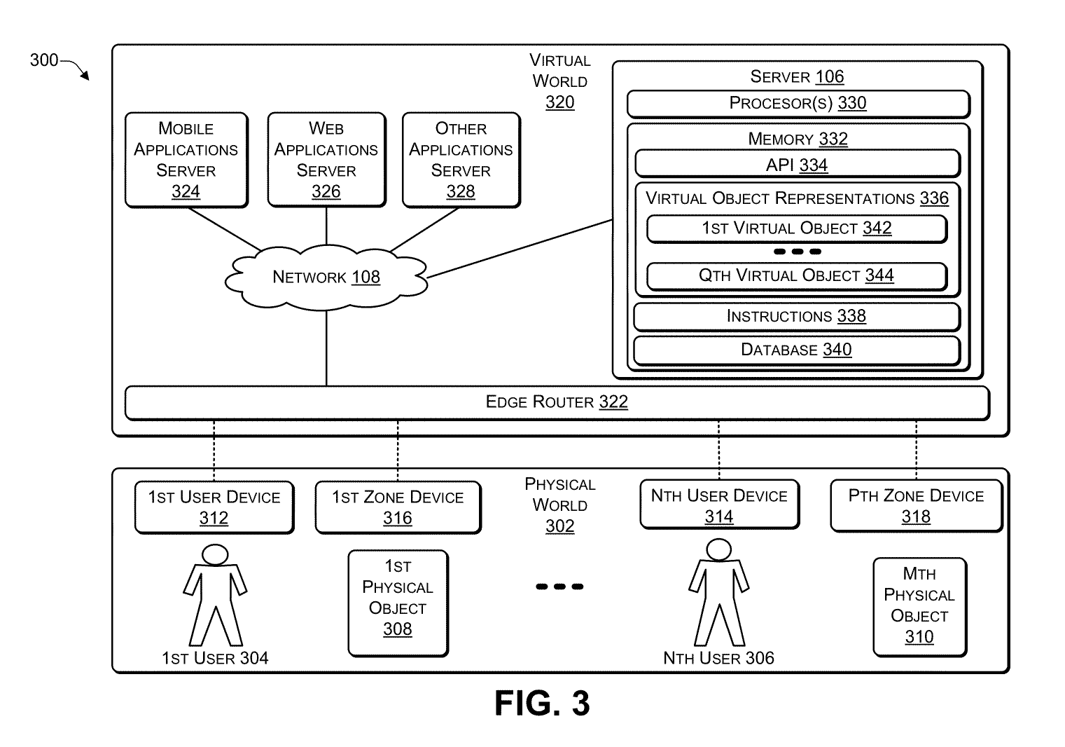

FIG. 3 illustrates an example framework 300 for creating an interactive virtual world according to some implementations. The framework 300 includes a physical world 302 that includes multiple users, such as a first user 304 and an Nth user 306 (where N>1), and multiple objects, such as the first physical object 308 and the Mth physical object 310 (where M>1 and where M may have a value that is different than N). Each of the users 304 and 306 may have an associated user device to enable the presence of the user to be detected. In the framework 300, a first user device 312 is associated with the first user 304 and an Nth user device 314 is associated with the Nth user 306.

The framework 300 includes multiple zone devices, such as the first zone device 316 and the Pth zone device 318 (where P>1 and where P may have a value that is different from M and N). Some but not all physical objects and physical environments (e.g., rooms) in the physical world may have a corresponding zone device. In some implementations, a particular zone device may be associated with multiple devices. For example, a single zone device may represent all the devices in a particular physical environment (e.g., a room) to enable a user to interact with the room as a single entity. Thus, the relationship between zone devices and physical objects may not be a one-to-one relationship. For example, there may be fewer zone devices than there are physical objects (e.g., P<M).

A virtual world 320 may enable the users 304 and 306 to interact with virtual object representations 336 that correspond to the physical objects 308 and 310. The virtual world 320 may include an edge router 322 and multiple servers coupled to the network 108. The multiple servers may include the server 106 and additional servers, such as a mobile applications server 324, a web applications server 326, and other applications server 328.

The edge router 322 may provide routing services for wireless traffic from the user devices 312 and 314 and the zone devices 316 and 318. The mobile applications server 324 may provide mobile applications, such as location-based services. For example, the mobile applications server 324 may provide a mapping service that provides a map identifying a location of a user, a destination specified by the user, or a route in the physical world 302 to the destination. As another example, the mobile applications server 324 may provide a location function that enables a user to locate a particular type of object or an object that provides a particular type of service. To illustrate, the first user 304 may desire to find a coffee maker or a vending machine. The mobile applications server 324 may provide a map identifying coffee makers or vending machines within a specified distance from the first user 304.

The web applications server 326 may provide web-based applications. The other applications server 328 may provide other applications that enable or provide services associated with the physical world 302 or the virtual world 320.

The server 106 may include one or more processors 330 and a memory 332. The memory 332 may include one or more of random access memory (RAM) and disk-based storage devices. The memory 332 may include an application programming interface (API) 334, virtual object representations 336, instructions 338, and a database 340. The API 334 may provide an interface to software architecture, such as a representational state transfer (REST) architecture, to enable software developers to write applications and services for the virtual world 320. The instructions 338 may be executable by the one or more processors 330 to perform the various functions of the server 106 as described herein, such as providing one of the virtual object representations 336 to one or more of the user devices 312 and 314 or providing location-based services to one or more of the user devices 312 and 314.

The virtual object representations 336 may include Q virtual objects. Some of the virtual object representations 336 may correspond to one or more of the physical objects 308 and 310 in the physical world 302 while others of the virtual object representations 336 may not correspond to any of the physical objects 308 and 310 in the physical world 302. For example, the Q virtual objects may include a first virtual object 342 and a Qth virtual object 344 (where Q>1 and where Q may have a different value than M, N, and P). At least some of the virtual objects 342 and 344 may provide virtual object representations that correspond to and enable a user to interact with one or more physical objects 308 and 310 in the physical world 302. Each of the virtual objects 342 and 344 may have associated properties that include one or more of states, actions, events, and children. For example, the states may include “on”, “off”, a temperature (e.g., a temperature of a room or of the temperature inside of a fridge), or another state associated with a device or a room. The actions may include instructing a physical object to transition from one state to another or instructing multiple devices to perform one or more actions to perform a particular function (e.g., “watch DVD”). For example, an action may instruct a physical object to transition from a “power on” state to a “power off” state or vice-versa. One or more of the users 304 and 306 may subscribe to events to receive a notification when the event occurs at a particular device. For example, a user may subscribe to an event to receive a notification when a particular user enters a room or when a particular user performs a login at a computing device.

Some of the virtual objects 342 and 344 may be purely virtual objects that do not correspond to physical objects in the physical world 302. For example, some of the virtual objects 342 and 344 may provide services, such as an SMS service to enable sending a text message (e.g., a message in a short message service format) to a particular phone number or an email service to enable sending an email to a particular email address.

The instructions 338 may be executable by the one or more processors 330 to provide a localization service for location-based services, such as mapping and navigation. For example, the localization service may determine locations of the users 304 and 306 and locations of the objects 308 and 310. The localization service may enable a location of a particular user to be determined via a user device associated with the particular user. For example, the first user 304 may determine a location of the Nth user 306 by requesting the localization service to determine a location of the Nth user device 314 that is associated with the Nth user 306. The localization service may enable a location of an object to be determined via the zone device associated with the object. For example, the first user 304 may determine a location of the Mth physical object 310 by requesting the localization service to determine a location of the Pth zone device 318 that is associated with the Mth physical object 310.

The database 340 may be used to store data associated with the users 304 and 306 and with the physical objects 308 and 310. For example, the database 340 may store a preferences file for each of the users 304 and 306. The user preferences file may enable a command to be automatically sent to a physical object when a particular user is detected within a zone associated with the physical object. For example, the first zone device 316 may be associated with a workspace (e.g., a cubicle or a room) associated with the first user 304. When the first user 304 enters the workspace, based on a preference file stored in the database 340, a computing device may be automatically (e.g., without the first user 304 taking any action) powered on, a lamp may be automatically powered on, and a state of a particular coffee maker may be determined. If the state of the particular coffee maker indicates that a carafe of the coffee maker has less than a cup of coffee, a subscription request may be automatically sent to the coffee maker based on the user preferences file requesting notification that coffee brewing has been initiated.

The network 108 may provide bi-directional traffic flow between the user devices 304 and 306, the zone devices 316-318, and the servers 106, 324, 326, and 328. The network 108 may carry upstream data from the user devices 304 and 306 and the zone devices 316-318. The data may be generated either reactively (e.g., location updates) or periodically (e.g., energy metering). In addition, the network 108 may transport downstream commands from the servers 106, 324, 326, and 328 to the user devices 304 and 306 and to the zone devices 316-318 (e.g., for querying and actuating sensors).

The network 108 may be configured to provide reliable data transport with relatively low latency. The network 108 may include a low-power networking fabric that connects the user devices 304 and 306 and the zone devices 316-318. The network 108 may include a fast networking fabric that connects the servers 106, 324, 326, and 328, as well as gateways (not shown) that link both of the networking fabrics. In some implementations, the network 108 may use Ethernet or similar technology to connect with the servers 106, 324, 326, and 328.

The low-power networking fabric of the network 108 that connects the user devices 304 and 306 and the zone devices 316-318 may use various technologies, including 802.15.4 compliant radios, single-hop or multi-hop network topologies, and Internet Protocol version 6 (IPv6). For example, the network 108 may enable data to travel via a single hop between the user devices 304 and 306 and the zone devices 316-318.

In some implementations, the network 108 may use IPv6 to link the user devices 304 and 306, the zone devices 316-318, and the servers 106, 324, 326, and 328 because the IPv6 address space enables each of them to have a unique and globally addressable IP address. For example, the network 108 may use an implementation of IPv6 over low power wireless personal area networks (referred to as 61oWPAN).

The states 120 may represent a snapshot of parameter values of the object 110 at a particular point in time. For example, a light fixture or a lamp may have an “on” state when the light has been turned on and have an “off” state when the light has been turned off. During a setup phase, objects (such as the object 110) may register with the server 106 and provide the server 106 with states (such as the states 120) that are associated with each of the objects. This registration may enable the users 304 and 308 to interact with the objects 308 and 310 via the virtualized object representations 336 that are hosted by the server 106.

The users 304 and 308 may interact with one or more of the objects 308 and 310 by selecting a command that instructs one or more of the objects 308 and 310 to change from one state (e.g., an “off” state) to another state (e.g., an “on” state). The users 304 and 308 may interact with one or more of the objects 308 and 310 by selecting a command to request a notification when particular events occur, such as when one or more of the objects 308 and 310 change from one state to another state.

The mobile applications server 324 may provide the users 304 and 306 with the services and tools to enable the users 304 and 306 to visualize data received from multiple objects and multiple users via their corresponding zone devices and user devices, respectively, remotely actuate one or more of the objects 308 and 310, and access personalized services provided by the objects 308 and 310 in the user's environment. Objects that are unknown to the user and services that are unknown to the user may be discovered through a data interchange protocol between the user's user device and the object's zone device.

Thus, the virtual world 320 may provide the virtual object representations 336 of the physical objects 308 and 310 to enable the users 304 and 306 to interact with the physical objects 308 and 310. The virtual object representations 336 may include properties, such as states, actions, and events, associated with each of the virtual objects 342 and 344. The applications servers 324, 326, and 328 may provide additional services to enable the users 304 and 306 to interact with the physical objects 308 and 310. In this way, the virtual world 320 can provide an enhanced interactive experience for the users 304 and 306 to interact with the physical objects 308 and 310 in the physical world 302.

### Hardware Architecture

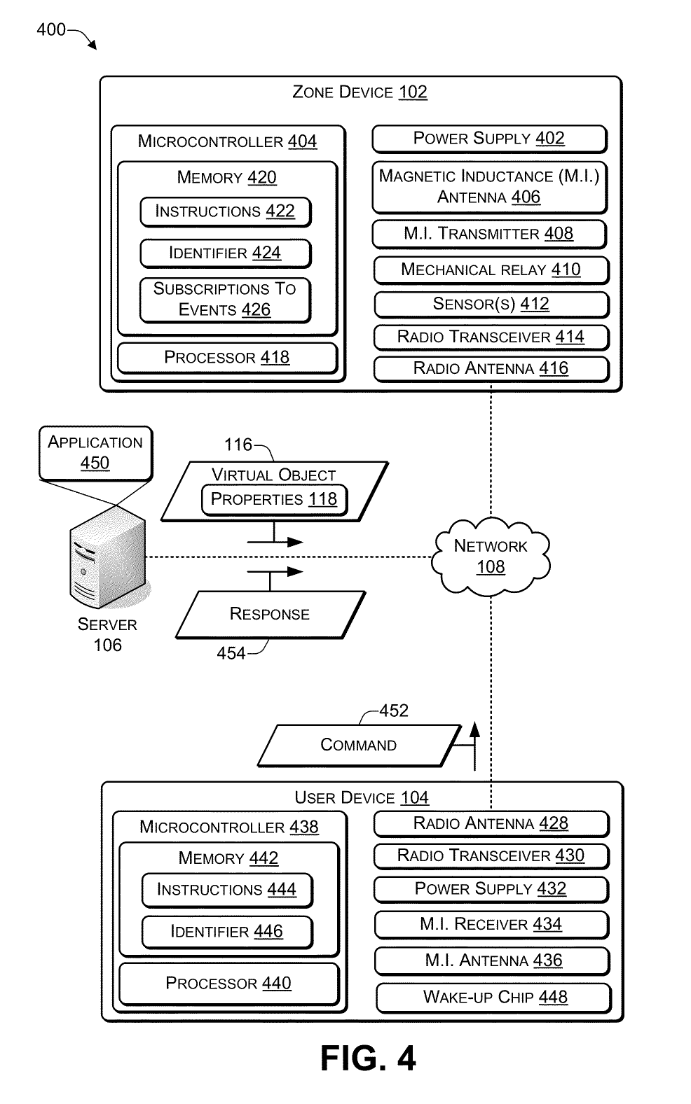

FIG. 4 illustrates an example hardware architecture 400 for creating interactive zones according to some implementations. In the hardware architecture 400, the zone device 102, the user device 104, and the server 106 are communicatively coupled to the network 108.

The zone device 102 may include a power supply 402, a microcontroller 404, a magnetic inductance antenna 406, a magnetic inductance transmitter 408, a mechanical relay 410, one or more sensor(s) 412, a radio transceiver 414, and a radio antenna 416. The microcontroller 404 may include a processor 418 and a memory 420. The memory 420 may include instructions 422 that are executable by the processor 418, an identifier 424, and subscriptions to events 426. The identifier 424 may uniquely identify the zone device 102. The instructions 422 may be executable by the processor 418 to perform the various functions provided by the zone device 102 as described herein, such as generating the zone 114, interacting with the user device 104, or interacting with the server 106.

The user device 104 may include a radio antenna 428, a radio transceiver 430, a power supply 432, a magnetic inductance receiver 434, a magnetic inductance antenna 436, and a microcontroller 438. The microcontroller 438 may include a processor 440 and a memory 442. The memory 442 may include instructions 444 that are executable by the processor 440 and an identifier 446. The instructions 444 may be executable by the processor 440 to perform the various functions of the user device 104 as described herein, such as detecting the presence of the zone 114, interacting with the zone device 102, or interacting with the server 106. The identifier 446 may uniquely identify the user device 104. In some implementations, the user device 104 may include a wake-up chip 448 while in other implementations the functionality of the wake-up chip may be performed by the microcontroller 438. The microcontrollers 404 and 438 may execute an operating system, such as TinyOS. TinyOS is an embedded operating system written in the nesC programming language as a set of cooperating tasks and processes.

To enable interaction, the zone device 102 may generate a clearly defined zone around a physical space (e.g., a room) or one or more objects (e.g., devices) that is persistent over time. To enable accurate indoor-localization and applications, such as occupant-tracking, indoor navigation, mapping, health monitoring, and other applications where humans interact with their surroundings, the zone device 102 accurately and reliably detects humans entering and exiting a zone, such as the zone 114. Precise and reliable indoor localization may be obtained by extending the zone 114 of the physical object 110 to a maximum radius of approximately three meters around the physical object 110. Smaller objects have proportionately smaller zones. In addition, the zone device 102 may detect that the user 112 has entered the zone 114 in less than 100 milliseconds (ms).

A space (e.g., a room) or a physical object (e.g., a refrigerator or a laptop) may have one or more associated zone devices that transmit dynamic magnetic fields. The magnetic field transmitted by the zone device 102 may be modulated to encode the identifier 424. The identifier 424 may be unique to the zone device 102. The identifier 424 may include information about the associated physical object, such as manufacturer information, a model number, a serial number of the associated physical object, IP (IPv6) address, other information, or any combination thereof. Strength of the magnetic field generated by the zone device 102 may be modulated to vary a diameter of the zone around a physical object as required. For example, when a new object is placed near an existing object, the zone around the existing object may be varied (e.g., reduced) to prevent the zone around the existing object from overlapping a zone around the new object. The user device 104 may be capable of reading the signal strength of the magnetic field generated by the zone device 102 and decoding the identifier 424.

One advantage of using a magnetic field rather than a radio signal (e.g., ZigBee® or WiFi®) is that the strength of the radio signal may vary, producing a large grey zone of reception. In contrast, magnetic field strength is relatively invariant and has a sharp falloff, producing a consistent boundary for a zone. Unlike radio signals, which drop off at 1/r² (e.g., the relationship of radio strength to distance is an inverse square relationship) a magnetic field drops off at 1/r³ (e.g., the relationship of magnetic field strength to distance is an inverse cube relationship). Compared to radios, magnetic fields produce a much sharper and more well-defined boundary given a specific receiver sensitivity, resulting in higher localization accuracy, typically at a sub-centimeter granularity. Furthermore, magnetic fields are not attenuated by non-metal obstacles and do not suffer from multipath effect. As a result, magnetic fields are more reliable and provide a more stable zone.

In some implementations, the power supply 402 may convert alternating current (A/C) power (e.g., 90 volts to 240 volts) to direct current (DC), and step down the DC to several different voltages to power the various components of the zone device 102. For example, the step-down DC voltages may include 3.3 volts, 5 volts, and 12 volts. In some implementations, such as outdoor applications, the power supply 402 may include a rechargeable battery that is charged via solar panels.

The magnetic inductance transmitter 408 may take in a modulated signal from the microcontroller 404, amplify the modulated signal, and transmit the modulated signal through the magnetic-inductive (MI) antenna. For example, a buffer plus inverter design may be used to create a large voltage swing. The magnetic inductance antenna 406 may be selected based on size considerations. The microcontroller 404 may encode the identifier 424 for transmitting via the magnetic inductance antenna 406, and may communicate with other networked devices via the radio transceiver 414 and the radio antenna 416. For example, the microcontroller 404 may be a system on a chip (SoC). In some implementations, the radio transceiver 414 and the radio antenna 416 may operate at 900 MHz.

The sensors 412 may include sensors that perform various functions. For example, when the zone device 102 and the user device 104 are used to measure the personal energy usage of the user 112, the sensors 412 may include a Hall-effect sensor for sensing current flow, and an energy metering chip for computing various aspects of power, such as real power, reactive power, cumulated energy, and power factor. The mechanical relay 410 enables remote actuation of electrical devices, such as appliances. In some implementations, the mechanical relay 410 may be rated up to 2500 watts.

The magnetic field may be generated in three stages. First, the microcontroller may encode the data to be transmitted. Second, the encoded data, in the form of a signal, may be amplified through a driver circuit to provide sufficient power. Third, the amplified signal may be delivered to the magnetic inductance antenna 406 for transmission. The range of the transmitted magnetic field may be a function of several parameters, including transmit power, a size of the magnetic inductance antenna 406, and a geometry of the magnetic inductance antenna 406. The magnetic inductance antenna 406 may be a PCB-mountable antenna with dimensions of 8 centimeters (cm) by 1.5 cm.

In some implementations, an input/output (I/O) pin from the microcontroller, signaling at 3.3 VDC, may be connected to the input of a buffer powered at 12 VDC and the output of the buffer may be connected to the input of an inverter, also powered at 12 VDC. The two ends of the magnetic inductance antenna 406 may be connected to the output of the buffer and to the output of the inverter. This type of design may be used to approximately double the voltage swing across the antenna, delivering a sufficient amount of power to enable use of the zone device 102.

In some implementations, power-limiting resistors may be put in series with the magnetic inductance antenna 406 so that the radius of the generated magnetic field may be reduced. In some implementations, a digitally controlled potentiometer may be used to dynamically adjust the radius of the generated magnetic field. For example, the radius of the generated magnetic field may be reduced when multiple physical objects are located close to one another to avoid overlapping the magnetic fields from each of the zone devices associated with the physical objects.

In some implementations, the magnetic inductance transmitter 406 may be tuned to 125 kHz. An on/off keying may be used to modulate data by generating a pulse-train of a specific duration to represent a 1, and an off to represent a 0. The duration of the pulse-train may determine a data rate and an error rate because shorter durations may result in higher data rates but also higher error rates. In some implementations, a data rate of 2730 bits per second (bps) may be used.

To mitigate interference and noise issues that may exist in modern office buildings, and to ensure adequate RF range indoors, the radio transceiver 414 in some implementations may use a transmission frequency below 1 GHz (e.g., 900 MHz) rather than 2.4 GHz. For example, the radio transceiver 414 may be compliant with the Institute of Electrical and Electronic Engineers (IEEE) 802.15.4 standard, such as 802.15.4 g.

To measure energy usage for an appliance, the appliance may be plugged directly into the zone device 102 for measurement. The sensors 412, such as a Hall-effect sensor and an energy metering chip, may provide real, apparent, and reactive power measurements.

The zone device 102 may be placed in an enclosure that is no larger than 12.4 cm by 7.0 cm by 4.1 cm. The magnetic induction antenna 406 may be affixed to the top of the enclosure.

In some implementations, the instructions 422 may append a 4-bit checksum to the 8-bit identifier 424 to form a payload. This payload may be pre-pended with a wake-up notification, synchronization bits, and preamble in order to wake-up and handshake with the corresponding radio transceiver 430 in the user device 104.

Magnetometers inside current generation wireless phones (e.g., using CDMA or GSM technologies) may be capable of detecting dynamic magnetic fields, such as those generated by the zone device 102, because most magnetometers use Hall-effect elements, which are responsive to both dynamic and static magnetic fields. However, in some wireless phones, the dynamic magnetic field may be filtered out to reduce noise from the earth's magnetic field. Thus, in some implementations, the functionality of the user device 104 may be incorporated into a wireless phone while in other implementations the user 112 may carry the user device 104 in addition to a wireless phone (or other mobile computing device). For example, some users may carry wireless phones with integrated user device functionality while other users may carry both the user device 104 and a wireless phone (or other mobile computing device).

The user device 104 may be a battery powered mobile device that is carried by a user to receive and decode identifiers, such as the identifier 424, from dynamic magnetic fields that are generated by zone devices, such as the zone device 102. The magnetic inductance receiver 434 may include a receiver coil that is tuned to approximately 125 kHz, and is sensitive in all three dimensions. Because a magnetic field is not attenuated significantly by non-ferrous material, a signal strength of a magnetic field that the magnetic inductance receiver 434 receives may be invariant relative to where the user device 104 is worn by a user. The user device 104 may be encased in an enclosure that is no more than 9.2 cm by 5.8 cm by 2.3 cm.

The outputs from the receiver coil of the magnetic inductance receiver 434 may be electrical signals in an “x” dimension, a “y” dimension, and a “z” dimension. These electrical signals may be connected to the wake-up chip 448. The wake-up chip 448 may be implemented as a low-power application specific integrated circuit (ASIC) that provides a number of functions, such as a programmable gain amplifier (PGA), digitizing the analog magnetic signals, and reducing power consumption of the user device 104 by signaling a wake-up signal to the microcontroller 438 when a magnetic field with a valid preamble is decoded. In some implementations, the functionality of the wake-up chip 448 may be performed by the microcontroller 426. For example, the microcontroller 426 may go into a reduced power mode in which the microcontroller 426 monitors the output of the magnetic inductance receiver 434.

In response to detecting electrical signals from the output of the magnetic inductance receiver 434 that indicate that the user device 104 has entered a zone generated by the zone device 102, the microcontroller 426 may wake-up to a full-function mode to determine whether the identifier 424 broadcast by the zone device 102 is valid. In the reduced power mode, the user device 104 may consume less power than when in the full-function mode. To enable portability, the power supply 432 may be a battery, such as a rechargeable (e.g., lithium ion) battery or a replaceable, one-time use battery. By using a low power mode, a life of the battery may be prolonged.

The microcontroller 426 and the radio transceiver 430 used in the user device 104 may be implemented using a system on a chip (SoC) that is capable of entering a low power mode. In response to being woken up by the wake-up chip 440, the microcontroller may use an internal timer to capture durations of the on/off intervals of the magnetic inductance field generated by the zone device 102. The on/off intervals may correspond to 1s and 0s of the identifier 424. The durations may be converted to bits by quantizing each duration by the length of a single bit (1/bit-rate). In another implementation, the data to be transmitted via the magnetic transmitter can be Manchester code, and recovered by the receiver by sampling the data pin on edges of the recovered Manchester clock. After verifying a checksum, the user device 104 may send the identifier 424 to an application 450 that is executing at the server 106. The identifier 424 may be sent via the radio transceiver 430 server via a user datagram protocol (UDP)/internet protocol (e.g., IPv6).

Based on the identifier 424, the application 450 may select the virtual object 116 that corresponds to a physical object (e.g., the object 110) that is associated with the zone device 102 and send the virtual object 116 to the user device 104 or to a user device (e.g., a wireless phone or other computing device) that is associated with the user 112. The user may send a command 452 to the server 106 based on the properties 118 of the virtual object 116. For example, the command 452 may query a state of the virtual object 116. As another example, the command 452 may include one or more actions to be performed by the virtual object 116, and by extension the corresponding physical object. As yet another example, the command 452 may include a subscription to an event requesting that the user be sent a notification when the specified event occurs.

In response to the server 106 receiving the command 452, the server may cause the physical object that corresponds to the virtual object 116 to perform one or more actions. For example, the server 106 may instruct the zone device 102 to route power, via the mechanical relay 410, to a physical object. As another example, the server 106 may instruct the zone device 102 to measure a characteristic (e.g., power consumption) of the physical object via one or more of the sensors 412.

After receiving the command 452, the server 106 may send a response 454 to the user device 104 or to a user device (e.g., a wireless phone or a computing device). The response 454 may provide a result of the command 452. For example, the response 454 may include a state of the physical object when the command 452 includes a request for the state of the physical object that is associated with the virtual object 116. As another example, the response 454 may include a result of the physical object performing one or more actions (e.g., a computing device has completed executing a reboot command). As yet another example, the response 454 may confirm a subscription to an event or may include a notification that the event has occurred when the command 452 is an event subscription.

The radio transceivers 414 and 430 may use a 2.4 GHz transceiver, a 900 MHz transceiver, a transceiver at another frequency, or any combination thereof. Because the 2.4 GHz is used by many devices, some implementations may use 900 MHz radios that are 802.15.4 g compliant. In addition, 900 MHz radios may have a longer transmission range and better object penetration, compared to the 2.4 GHz band. 802.15.4 g is a PHY layer amendment to the 802.15.4 standard, and is designed to provide a global standard for facilitating large-scale control applications.

Thus, the zone device 102 may be capable of generating a precise zone around a physical object via magnetic inductance. The zone device 102 may transmit an identifier 424 that uniquely identifies the zone device 102. The user device 104 may be capable of detecting when the user device 104 enters the zone generated by the zone device 102. When the user device 104 detects that it has entered the zone, the user device 104 may decode the identifier 424 and send the identifier 424 to the server 106. In response, the server 106 may identify the virtual object 116 that represents the physical object associated with the zone device 102 and send the virtual object 116 to the user device 104 or to a user device (e.g., a wireless phone) to enable a user to interact with the physical object via the virtual object 116.

### Framework for Creating Interactive Zones

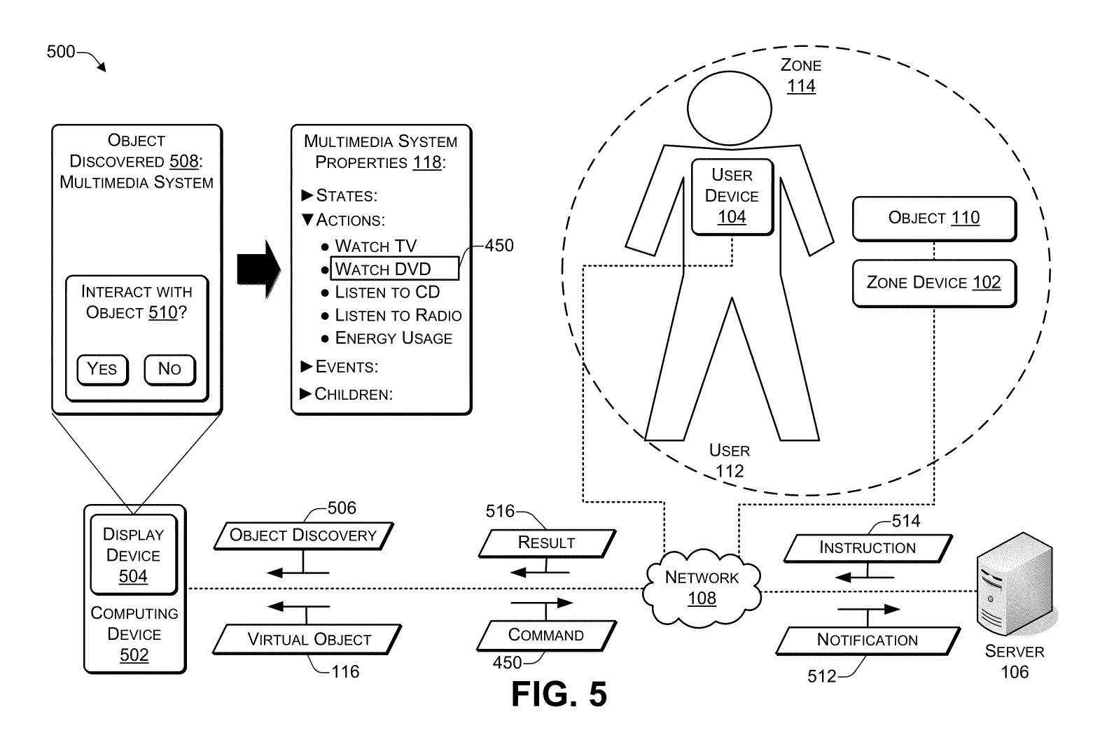

FIG. 5 illustrates an example framework 500 for creating interactive zones according to some implementations. The framework 500 may include a computing device 502 that includes a display device 504. The computing device 502 may be a computing device, such as a laptop computer, a tablet computing device, a wireless phone, a personal digital assistant, another type of computing device, or any combination thereof. The user device 104 may be separate from the computing device 502 or the functionality of the user device 104 may be incorporated into the computing device 502. The computing device 502 may be associated with the user 112.

In operation, the user 112 may enter the zone 114 that is generated by the zone device 112 around the object 110. Either the user device 104 or the zone device 102 may detect that the user 112 has entered the zone 114. Either the user device 104 or the zone device 102 may send a notification 512 message to the server 106 that the user 112 has entered the zone 114. The notification 512 message may include the identifier 424 that is broadcast by the zone device 102 when generating the zone 114. The server 106 may send an object discovery 506 message to the computing device 502 via the network 108. For example, the object discovery 506 message may be sent via magnetic inductance, via a low power 900 MHz or 2.4 GHz wireless frequency, or via a commercial wireless network, such as a CDMA or GSM network, or any combination thereof.

The computing device 502 may receive the object discovery 506 message and instruct the display device 504 to display an object discovered 508 message that identifies the object 110. In this example, the object discovered message indicates that the object 110 is a multimedia system (e.g., the multimedia system 220).

The server 106 may send the virtual object 116 to the computing device 502. In some implementations, the server 106 may automatically send the virtual object 116 to the computing device 502 in response to receiving the notification 512. In other implementations, the computing device 502 or the server 106 may determine whether the user 112 desires to interact with the object 110 via the virtual object 116 by instructing the display device 504 to display an interaction with object 510 message.

The computing device 502 may instruct the display device 504 to display the virtual object 116. For example, the properties 118 of the multimedia system 220 may be displayed to enable the user 112 to select the command 450 based on the properties 118. After the user 112 selects the command 450, the command 450 may be sent to the server 106 or to the zone device 102. The server 106 may receive the command 450 and send an instruction 514 to cause the object 110 to perform one or more actions. For example, when the command 450 is “watch DVD”, the server 106 may send the instruction 514 to the zone device 512 or to the multimedia system 220. The instruction 514 may cause the multimedia system 220 to power on a DVD player, power on a receiver, power on a television, and select an input on the receiver that receives output from the DVD player.

In some implementations, the interact with object 510 message may be displayed to determine whether the user 112 desires to interact with the object 110 via a virtual representation while in other implementations the virtual object 116 may be sent without displaying the interact with object 510 message. In some implementations, a user preferences file (not shown) may be stored at the computing device 502 or the server 106. The user preferences file may specify certain types of objects that the user 112 desires to interact with, and when the user 112 enters the zone 114 of a specified type of object, the virtual object 116 may be automatically sent to the user 112 without displaying the interact with object 510 message. For example, when the user 112 is a coffee drinker, the user preferences file may specify that when the user 112 enters the zone 114 of a coffee machine, the virtual object 116 is sent without displaying the interact with object 510 message. As another example, when the user 112 is a coffee drinker, the user preferences file may specify that a state (e.g., when a carafe of the coffee maker has at least one cup of coffee) of the coffee machine be automatically sent to the computing device 502. As yet another example, when the user 112 is not a coffee drinker, the user preferences file may specify that when the user 112 enters the zone 114 of a coffee machine, the object discovery 506 message is not sent to the computing device 502 or the object discovery 506 message is sent and the interact with object 510 message is displayed.

The server 106 may determine a result 516 of sending the instruction 514, e.g., was the instruction successfully carried out or not. The server 106 may send the result 516 to the computing device 502 for display at the display device 504 to inform the user 112 of the result of the selecting the command 450.

Each object (e.g. the object 110) may be associated with a different set of states, commands, and events. Objects that have a same type may still have different sets of states, commands, and events. For example, one light switch may be a simple on/off switch while another light switch may be continuously variable. Therefore, before interacting with a particular object, such as the object 110, the user 112 may be provided with properties (e.g., the properties 118) of the object 110. In some implementations, a handshake between the user device 104 and the zone device 102 may be used to provide the user 112 with the properties 118 of the object 110.

A data interchange protocol may enable the handshake that provides the properties 118 (e.g., states, commands and events) of the object 110. The data interchange protocol may be flexible enough to accommodate different naming schemes of various manufacturers. In some implementations, JavaScript Object Notation (JSON) may be used data that represents the object 110 in messages between the user device 104, the zone device 104, and the server 106. JSON messages are text-based, human-readable, self-describing, and language independent. Compared to extended markup language (XML), JSON is light-weight with a smaller grammar and relatively simpler data structure, resulting in lower computational overhead and reduced memory requirements. JSON messages may be carried within HTTP traffic. Using HTTP, an object ID and a message type may be exposed inside the URL.

In some implementations, when the user device 104 is detected within the zone 114 generated by the zone device 102, the zone device 102 may use magnetic-induction to send its IPv6 address or IPv6 suffix to the user device 104 or to the computing device 502. After the IPv6 address is received by the user device 104 or by the computing device 502, the user 112 may be notified of the discovery of a new object (e.g., the multimedia system 220) via the object discovery 506 message. When the user indicates a desire to see more information about this object via the interact with object 510 message, the IPv6 address may be RESTfully queried, and a JSON object may be sent to the user device 104 or to the computing device 502. The contents of the JSON object may be presented to the user 112 via the properties 118 menu. In this example, the user 112 is presented with metadata of the multimedia system 220, including current states of the multimedia system 220, available commands the user can act on multimedia system 220, or events to which the user 112 can subscribe. The properties 118 menu may also enable the user 112 to view children objects of the multimedia system, such as the DVD player, receiver, or television, and gain further information from the children objects by RESTfully querying their IPv6 address through the properties 118 menu.

Once the user 112 has discovered the object 110, metadata associated with the object 112 may be cached within the computing device 502 for future use. Subscription to updates through events or remote actuation through actions associated with the object 110 may enable the user 112 to interact with the object 110 remotely, without the user 112 being located in close proximity to the object 110.

To illustrate how the framework 500 may be used, an example of a web application that provides information on individual energy usage is described. After registering with the web application, a user may register the user's appliances through the web application by providing a name, a type, and a zone device associated with each appliance. The web application uses the zone device's IP address to subscribe to periodic updates of the energy usage of the appliances; this data may be used to visualize an energy usage of the appliances via a graph on the user's profile page. Users can track the energy usage of others and compare energy usage profiles to see which user is using the least amount of energy. A summary of energy usage statistics for each user may be provided to increase awareness of energy usage amongst users.

The web application may apportion energy usage of publicly used appliances, such as coffee machines, microwaves, or projectors in an office. Precise occupant tracking by the user device 104 may be used to correlate usage of each appliance to the window of time during which a particular user interacted with the virtual object representation of the appliance. For example, when the object 110 is a coffee machine, the framework 500 may determine, based on the period of time during which the user is in front of the coffee machine dispensing a cup of coffee, that the user is responsible for the amount of energy consumed within this period of time.

As another illustration of using the framework 500, a web application may be used to locate an employee. For example, the employee may be away from their workspace/desk for a meeting in a conference room, in the kitchen for a cup of coffee, in the bathroom, etc. To facilitate locating the employee, the web application may request each user's user device IPv6 address upon registration, so that followers of the user can quickly ascertain the most recent location of the user.

The framework 500 may also support user-proximity based appliance automation. For example, a coffee machine may start preheating when the zone device 102 detects the user device 104 in the virtual zone 114 around the coffee maker. In addition, the coffee maker shut off when no users are detected within the zone for a pre-determined period of time.

Thus, when the user 112 enters the zone 114 associated with the object 110, the user 112 may be notified that the user may interact with the object 110 via the virtual object 116. The user 112 may interact with the virtual object 116 by selecting the command 450. The command 450 may determine a state of the object 110, cause the object 110 to perform one of more actions, or subscribe to receive notification when a particular event occurs at the object 110. The result 516 of selecting the command 450 may be displayed by the computing device 502.

### Example Processes

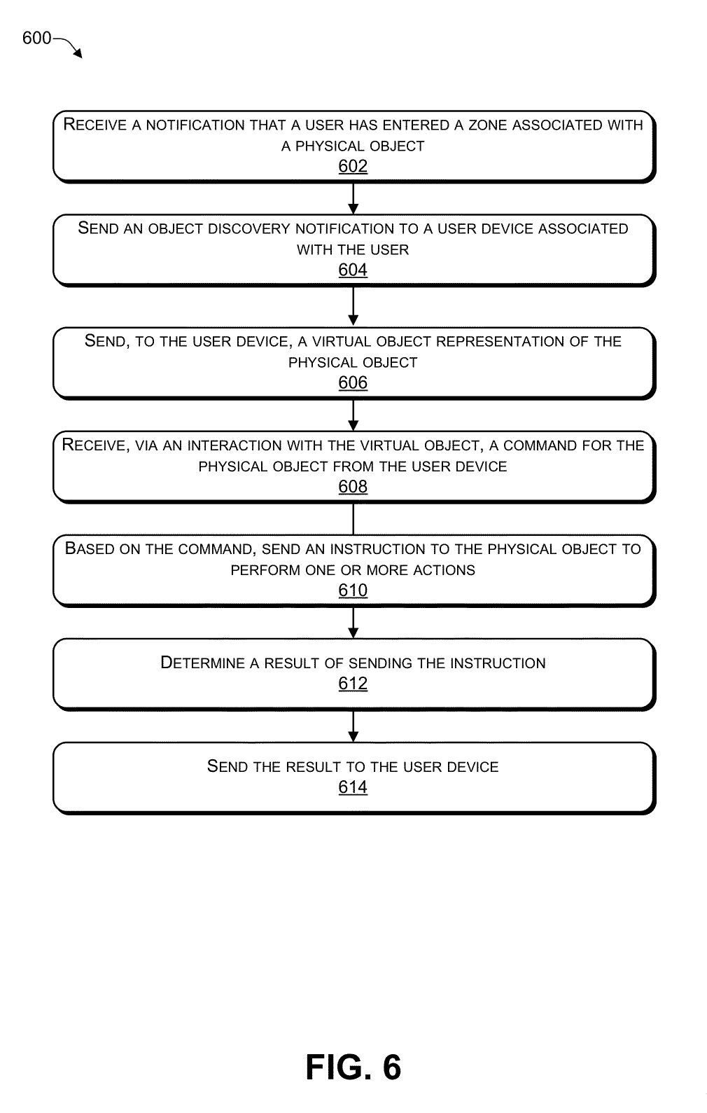

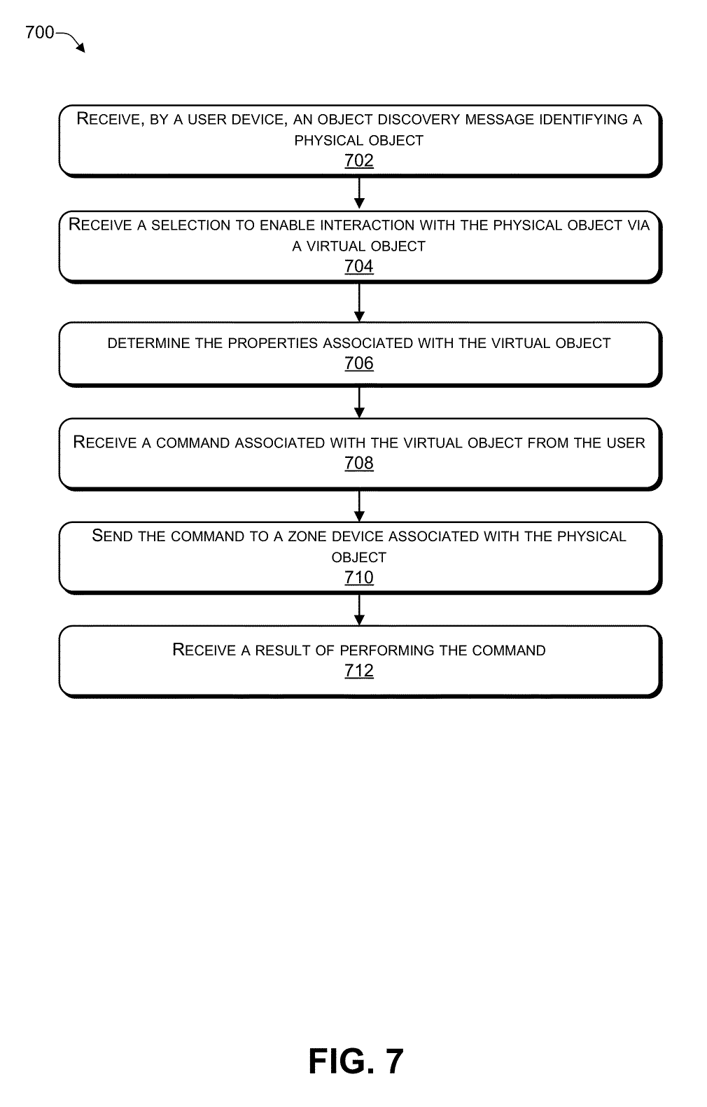

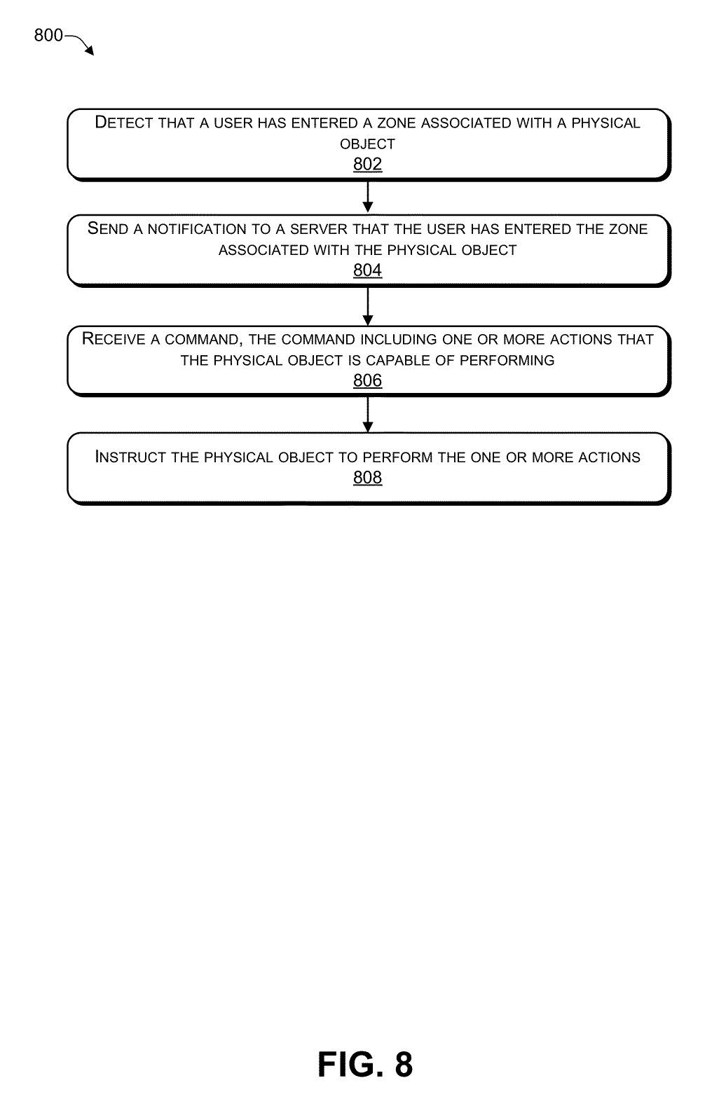

FIG. 6 is a flow diagram of an example process 600 that includes receiving a notification that a user has entered a zone according to some implementations. Additionally, FIG. 7 is a flow diagram of an example process 700 that includes receiving an object discovery notification identifying a physical object according to some implementations, and FIG. 8 is a flow diagram of an example process that includes detecting that a user has entered a zone according to some implementations. In the flow diagrams of FIGS. 6, 7, and 8, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 600, 700, and 800 are described with reference to the frameworks 100, 300, 400, and 500 described above, although other models, frameworks, systems and environments may implement these processes.

At block 602, a notification that a user has entered a zone associated with a physical object is received. For example, the server 106 may receive the notification 512 that the user 112 has entered the zone 114 associated with the object 110. The notification 512 may be sent by the zone device 102 or by the user device 104.

At block 604, an object discovery notification is sent to a user device associated with the user. For example, the object discovery 506 message may be sent to the computing device 502 that is associated with the user 112. The object discovery message 506 may be sent by the server 106 in response to an instruction from the zone device 102 or from the user device 104.

At block 606, a virtual object representation including properties of the physical object may be sent to the user device. For example, the virtual object 116 that represents the object 110 may be sent to the computing device 502 from the server 106.

At block 608, a command for the physical object is received from the user device via an interaction with the virtual object. For example, the server 106 may receive the command 450 after the user 112 interacts with the properties 118 of the virtual object 116 that are displayed at the display device 504.

At block 610, an instruction to perform one or more actions is sent to the physical object based on the command. For example, the server 106 may send the instruction 514 in response to receiving the command 450. The instruction may be sent to the zone device 102, the object 110, or both. For example, the instruction 514 may cause the zone device 102 to provide power to the multimedia system 220 by actuating the mechanical relay 410 and cause the multimedia system 220 to select a first device (e.g., a DVD player) to provide audio input and video input, a second device (e.g., a television) to output the video input, and a third device (e.g., a receiver or amplifier) to output the audio input.

At block 612, the server 106 may determine a result of sending the instruction 514. For example, the server 106 may determine whether the multimedia system 220 successfully powered on and whether the appropriate input and output devices were selected in response to sending the instruction 514.

At block 614, the server 106 may send the result 516 to the computing device 502. The computing device 502 may display the result 516 at the display device 504.

FIG. 7 is a flow diagram of an example process 700 that includes receiving an object discovery notification identifying a physical object according to some implementations.

At block 702, an object discovery identifying a physical object is received by a user device. For example, the computing device 502 may receive the object discovery 506 message in response to the user 112 entering the zone 114.

At block 704, a selection to enable interaction with the physical object via a virtual object is received. For example, the user 112 may provide a selection in response to the interaction with object 510 message that indicates that the user desires to interact with the object 110 via the virtual object 116.

At block 706, properties associated with the virtual object are determined. For example, the computing device 502 may send a request to the server 106 to determine the properties 118 of the virtual object 116. In response, the server 106 may send the virtual object 116 including the properties 118.

At block 708, the computing device 502 receives the command 450 associated with the virtual object 116 from the user 112. For example, the user 112 may select the command 450 after the properties 118 of the virtual object 116 are displayed at the display device 504.

At block 710, the command is sent to a zone device associated with the physical object. For example, the server 106 may send the instruction 514 to the zone device 102, the object 110, a proxy device, or any combination thereof to cause the object 110 to perform one or more actions associated with the command.

At block 712, a result of performing the command may be received. For example, the user server 106 may determine the result 516 of sending the instruction 514 and send the result 516 to the computing device 502.

FIG. 8 is a flow diagram of an example process 800 that includes detecting that a user has entered a zone according to some implementations.

At block 802, a user is detected as having entered a zone associated with a physical object. For example, the zone device 102 may detect via the magnetic inductance antenna 406 that the user 112 has entered the zone 114 by detecting the presence of the user device 104 in the zone 114.

At block 804, a notification is sent to a server that the user has entered the zone associated with the physical object. For example, the zone device 102 may send the notification 512 to the server 106. In response to the notification 512 from the zone device 102, the server 106 may send the properties 118 to the user device 104 or the computing device 502.

At block 806, a command including one or more actions that the physical object is capable of performing may be received. For example, the zone device 102 may receive the command 450 from the computing device 502 or from the user device 104.

At block 808, the physical object may be instructed to perform the one or more actions. For example, in response to receiving the command 450, the zone device 102 may instruct the object 110 to perform the one or more actions. In some implementations, the zone device 102, the server 106, or a combination of both may determine a location of the user 112 in three dimensional space. The zone device 102 may instruct the object 110 to perform the one or more actions based on the location of the user 112.

### Example Computing Device and Environment

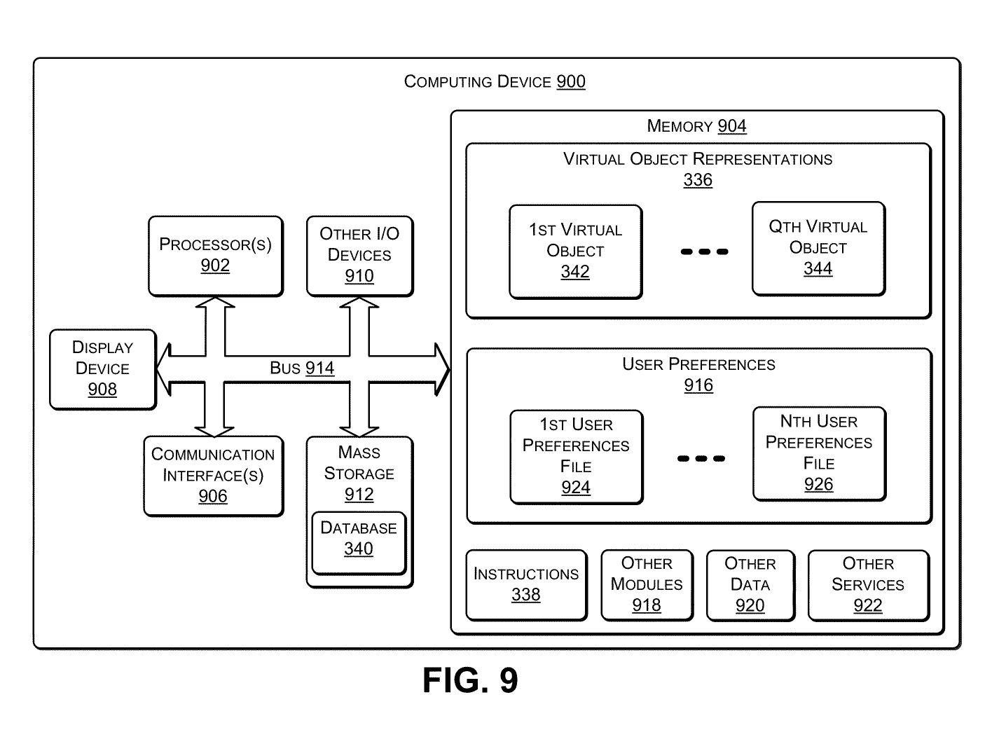

FIG. 9 illustrates an example configuration of a computing device 900 and environment that can be used to implement the modules and functions of the server 106 described herein. The computing device 900 may include one or more processor(s) 902, a memory 904, communication interfaces 906, a display device 908, other input/output (I/O) devices 910, and one or more mass storage devices 912, able to communicate with each other, such as via a system bus 914 or other suitable connection.

The processor 902 may be a single processing unit or a number of processing units, all of which may include single or multiple computing units or multiple cores. The processor 902 can be implemented as one or more microprocessors, microcomputers, microcontrollers, digital signal processors, central processing units, state machines, logic circuitries, and/or any devices that manipulate signals based on operational instructions. Among other capabilities, the processor 902 can be configured to fetch and execute computer-readable instructions stored in the memory 904, mass storage devices 912, or other computer-readable media.

Memory 904 and mass storage devices 912 are examples of computer storage media for storing instructions which are executed by the processor 902 to perform the various functions described above. For example, memory 904 may generally include both volatile memory and non-volatile memory (e.g., RAM, ROM, or the like). Further, mass storage devices 912 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 904 and mass storage devices 912 may be collectively referred to as memory or computer storage media herein, and may be a non-transitory media capable of storing computer-readable, processor-executable program instructions as computer program code that can be executed by the processor 902 as a particular machine configured for carrying out the operations and functions described in the implementations herein. The mass storage 912 may include the database 340.

The computing device 900 may also include one or more communication interfaces 906 for exchanging data with other devices, such as via a network, direct connection, or the like, as discussed above. The communication interfaces 906 can facilitate communications within a wide variety of networks and protocol types, including wired networks (e.g., LAN, cable, etc.) and wireless networks (e.g., WLAN, cellular, satellite, etc.), the Internet and the like. Communication interfaces 906 can also provide communication with external storage (not shown), such as in a storage array, network attached storage, storage area network, or the like.

A display device 908, such as a monitor may be included in some implementations for displaying information and images to users. Other I/O devices 910 may be devices that receive various inputs from a user and provide various outputs to the user, and may include a keyboard, a remote controller, a mouse, a printer, audio input/output devices, and so forth.

Memory 904 may include modules and components for providing zone-based services according to the implementations described herein. In the illustrated example, the memory 904 includes the virtual object representations 336, the instructions 338, user preferences 916, other modules 918, other data 920, and other services 922.

The user preferences 916 may include N user preferences files, such a first user preferences file 924 associated with the first user 304 and an Nth user preferences file 926 associated with the Nth user 306. The user preferences files 924 and 926 may include information about interaction preferences for the associated user, such as a default interaction with particular physical objects. The user preferences files 924 and 926 may identify specific commands to be performed at particular times and/or particular dates. For example, the first user preferences file 924 may automatically power on a computing device (e.g., the object 110) and login the first user 304 in response to the first user 304 entering the zone 114 between 8:00 AM and 9:00 AM and automatically logout the first user 304 and power off the computing device in response to the first user 304 exiting the zone 114 after 4:00 PM. As another example, the first user preferences file 924 may automatically determine a state of a particular coffee maker in response to the first user 304 entering the zone 114 after 8:00 AM and, if the state indicates that the coffee maker has less than a cup of coffee available, a request for a subscription to a coffee brewing event may be automatically sent to notify the first user 304 when a fresh pot of coffee is brewing.

The other modules 918 may perform other functions related to providing zone-based services. The other data 920 may include other data associated with providing zone-based services. The other services 922 may include various zone-based services, such as mapping (e.g., “you are here”), navigation (e.g., “turn left at the next hallway and walk ten feet to reach your destination”), and finding a nearest particular type of device (e.g., “the nearest coffee maker is in room 218—would you like directions?”).

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although illustrated as being stored in memory, the instructions 338, the instructions 422, the instructions 444 or portions thereof, may be implemented using any form of computer-readable media that is accessible by computing device 900. As used herein, “computer-readable media” includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
receiving a notification that a user has entered a zone associated with a physical object, the zone created via magnetic inductance;
sending, to a computing device associated with the user, a virtual object representation of the physical object;
receiving a command for the physical object from the computing device; and
in response to receiving the command, sending an instruction that causes the physical object to perform one or more actions.

2. The method of claim 1, further comprising:
determining a result of causing the physical object to perform the one or more actions; and
sending the result to the user device.

3. The method of claim 1, further comprising:
receiving an event subscription request for an event associated with the physical object; and
associating the user device with the event.

4. The method of claim 3, further comprising, in response to detecting that the event associated with the physical object has occurred, sending an event notification to the user device.

5. The method of claim 1, further comprising performing a discovery handshake with the user device after detecting that the user has entered the zone.

6. The method of claim 1, further comprising sending at least a portion of an internet protocol address to the user device after detecting that the user has entered the zone.

7. The method of claim 1, wherein the user device is a wireless computing device.

8. The method of claim 1, wherein the virtual object representation includes properties associated with the physical object.

9. The method of claim 8, wherein the properties include metadata identifying one or more a state associated with the physical object, a command associated with the physical object, or an event associated with the physical object.

10. The method of claim 1, wherein the virtual object representation includes data identifying a hierarchical relationship between the physical object and one or more additional objects that are associated with the physical object.

11. A user device comprising:
one or more processors; and
computer-readable storage media including instructions executable by the one or more processors to perform operations comprising:
receiving, from a server, a virtual object corresponding to a physical object, the virtual object including properties associated with the virtual object;
providing the virtual object for display at a display device, the virtual object having interactive properties;
receiving a selection identifying a first command based on the interactive properties;
sending the first command to the server; and
receiving, from the server, a result of performing the first command.

12. The computer-readable media of claim 11, the operations further comprising:
before receiving the virtual object, receiving an object discovery notification identifying the physical object;
providing an indication to the user that the physical object has been identified; and
receiving an instruction from the user to enable interaction with the physical object.

13. The computer-readable media of claim 11, wherein the virtual object includes one or more states associated with the physical object.

14. The computer-readable media of claim 11, wherein the virtual object includes one or more events associated with the physical object.

15. The computer-readable media of claim 14, the operations further comprising:
receiving a second selection from the user identifying a particular event of the one or more events; and
sending an event subscription request to a zone device associated with the physical object, the event subscription request identifying the particular event.

16. The computer-readable media of claim 15, the operations further comprising:
receiving a notification that the particular event has occurred; and
sending a second command of the plurality of commands to the zone device associated with the physical object.

17. A system comprising:
a zone device including a processor and a memory to store instructions, the instructions executable by the processor to perform operations comprising:
detecting, via a magnetic inductance antenna, that a user has entered a zone associated with a physical object;
sending, via a radio transceiver, a notification to a server that the user has entered the zone associated with the physical object; and
receiving a command via a radio antenna, the command including one or more actions that the physical object is capable of performing.

18. The system of claim 17, wherein the operations further comprise determining a location of the user in three dimensional space.

19. The system of claim 18, wherein the operations further comprise instructing the physical object to perform the one or more actions based on the location of the user and based on the command.

20. The system of claim 17, wherein, after detecting that the user has entered the zone, the operations further comprise automatically instructing the physical object to perform one or more actions.
